(19) United States
(12) Patent Application Publication
(10) Pub. No.: US 2019/0022864 A1
(43) Pub. Date: Jan. 24, 2019

(54) ROBOT CONTROL DEVICE, ROBOT SYSTEM, AND SIMULATION DEVICE

(71) Applicant: Seiko Epson Corporation, Tokyo (JP)

(72) Inventor: Yasuhiro SHIMODAIRA, Matsumoto (JP)

(21) Appl. No.: 16/041,972

(22) Filed: Jul. 23, 2018

(30) Foreign Application Priority Data
Jul. 24, 2017 (JP) 2017-142450

(51) Int. Cl. B25J 9/16; B25J 13/08

(52) U.S. Cl. CPC B25J 9/1671; B25J 13/088; B25J 13/085; B25J 9/1633

(57) ABSTRACT

A robot control device includes a processor that is configured to execute computer-executable instructions so as to control a robot including a robot arm, an end effector detachably attached to the robot arm and configured to hold an object, and a force detecting device. the processor is configured to: calculate, on the basis of position and posture information of a first point of the robot arm and relative position and posture information of a second point of the object with respect to the first point, position and posture information of the second point when the robot operates; and cause a memory to store the position and posture information of the second point.

### BACKGROUND

### 1. Technical Field

The present invention relates to a robot control device, a robot control method, a robot system, and a simulation device.

### 2. Related Art

There is known a robot including a base and a robot arm including a plurality of arms (links). One arm of two arms adjacent to each other of the robot arm is turnably coupled to the other arm via a joint section. An arm on the most proximal end side (the most upstream side) is turnably coupled to the base via a joint section. The joint sections are driven by motors. The arms turn according to the driving of the joint sections. For example, a hand is detachably attached to an arm on the most distal end side (the most downstream side) as an end effector. For example, the robot grips an object with the hand, moves the object to a predetermined place, and performs predetermined work such as assembly.

A robot control device that controls driving (operation) of such a robot sets, when the robot operates, the center point of the distal end of the hand as a control point (a tool control point). The robot control device stores position and posture information indicating the position and the posture of the control point. A user can grasp the position and the posture of the control point of the robot with the position and posture information.

JP-A-2017-1122 (Patent Literature 1) discloses a robot control device that controls driving of a robot. The robot control device disclosed in Patent Literature 1 stores position and posture information of a control point, sets a contact point between a work tool attached to the distal end of a robot arm and work as a working point, and displays a track of the working point on a display device.

However, in the robot control device in the past, the position and posture information stored when the robot operates is the position and posture information of the control point. Therefore, for a person unfamiliar with robotics, it is difficult to grasp, with the position and posture information, the operation performed by the robot.

The robot control device disclosed in Patent Literature 1 displays the track of the working point on the display device. However, information necessary for the person unfamiliar with robotics is sometimes not only the working point but also information concerning a part that is not connected (in contact). It is difficult to grasp, only with the working point, the operation performed by the robot. Note that, when the robot performs, for example, work for fitting an object, a situation in which the fitting is half-finished cannot be calculated by a combination of angles of a roll, a pitch, and a yaw.

### SUMMARY

An advantage of some aspects of the invention is to solve at least a part of the problems described above, and the invention can be implemented as the following aspects or application examples.

A robot control device according to an aspect of the invention is a robot control device including a control section configured to control a robot including a movable section including a robot arm, an end effector detachably attached to the robot arm and configured to hold an object, and a force detecting device. When the robot operates, the control section calculates, on the basis of position and posture information of a first point of the robot arm and relative position and posture information of a second point of the object with respect to the first point, position and posture information of the second point and causes a storing section to store the position and posture information of the second point.

With such a robot control device according to the aspect of the invention, it is possible to easily and quickly grasp, with the position and posture information of the second point, operation performed by the robot.

In the robot control device according to the aspect of the invention, it is preferable that, when the robot operates, the control section calculates, on the basis of force information detected by the force detecting device, a force applied to the second point and causes the storing section to store information concerning the force applied to the second point.

With this configuration, it is possible to grasp the force applied to the second point.

In the robot control device according to the aspect of the invention, it is preferable that the robot control device includes a display control section configured to control driving of a display device, and the display control section causes the display device to display, as a list, the position and posture information of the second point stored in the storing section and information concerning a force applied to the second point stored in the storing section.

With this configuration, by viewing the information displayed on the display device, it is possible to easily and quickly grasp operation performed by the robot and a force applied to the movable section in the operation.

In the robot control device according to the aspect of the invention, it is preferable that the second point is set independently from a control point set in the end effector.

With this configuration, when the control point is changed, position and posture information of the control point is changed but the position and posture information of the second point is not changed. Therefore, it is possible to accurately grasp the operation performed by the robot.

In the robot control device according to the aspect of the invention, it is preferable that the position and posture information of the second point is calculated on the basis of a local coordinate system different from a base coordinate system of the robot.

With this configuration, it is possible to easily grasp the position and the posture of the second point according to disposition and a posture in a site and the shape of the object (a space of the shape of the object).

In the robot control device according to the aspect of the invention, it is preferable that the control section calculates position and posture information of a third point on the basis of the position and posture information of the second point and joint angle information of the robot arm.

With this configuration, it is possible to more easily and quickly grasp the operation performed by the robot.

In the robot control device according to the aspect of the invention, it is preferable that, when the robot operates, the control section causes the storing section to store position and posture information of a control point set in the end effector and controls the robot on the basis of the position and posture information of the control point stored in the storing section.

With this configuration, when the robot is operated, it is possible to easily reproduce at least a part of the operation.

In the robot control device according to the aspect of the invention, it is preferable that, when the robot operates, the control section causes the storing section to store joint angle information of the robot arm and controls the robot on the basis of the joint angle information of the robot arm stored in the storing section.

With this configuration, when the robot is operated, it is possible to easily reproduce at least a part of the operation.

In the robot control device according to the aspect of the invention, it is preferable that, when the robot operates, the control section causes the storing section to store information concerning a joint flag and controls the robot on the basis of the information concerning the joint flag stored in the storing section.

With this configuration, when the robot is operated, it is possible to easily reproduce at least a part of the operation.

A robot control method according to another aspect of the invention is a robot control method for controlling a robot including a movable section including a robot arm, an end effector detachably attached to the robot arm and configured to hold an object, and a force detecting device. The robot control method includes, when the robot operates, calculating, on the basis of position and posture information of a first point of the robot arm and relative position and posture information of a second point of the object with respect to the first point, position and posture information of the second point and causing a storing section to store the position and posture information of the second point.

With such a robot control method according to the aspect, it is possible to easily and quickly grasp, with the position and posture information of the second point, operation performed by the robot.

A robot system according to still another aspect of the invention includes: a robot including a movable section including a robot arm, an end effector detachably attached to the robot arm and configured to hold an object, and a force detecting device; and the robot control device according to the aspect that controls the robot.

With such a robot system according to the aspect, it is possible to easily and quickly grasp operation performed by the robot with the position and posture information of the second point.

A simulation device according to still another aspect of the invention is a simulation device that performs operation of a virtual robot on a virtual space displayed on a display device. The virtual robot includes a virtual movable section including a virtual robot arm, a virtual end effector detachably attached to the virtual robot arm and configured to hold a virtual object, and a virtual force detecting device. The simulation device includes a control section configured to, when the virtual robot operates, calculate, on the basis of position and posture information of a first point of the virtual robot arm and relative position and posture information of a second point of the virtual object with respect to the first point, position and posture information of the second point and cause a storing section to store the position and posture information of the second point.

With such a simulation device according to the aspect, it is possible to easily and quickly grasp, with the position and posture information of the second point, operation performed by the virtual robot.

In the simulation device according to the aspect of the invention, it is preferable that, when the virtual robot operates, the control section causes the storing section to store information concerning a force applied to predetermined portion of the virtual movable section and causes the display device to display, together with the virtual robot, as an arrow, the information concerning the force stored in the storing section.

With this configuration, it is possible to easily and quickly grasp, with the display as the arrow, the force applied to the predetermined portion of the virtual movable section.

### BRIEF DESCRIPTION OF THE DRAWINGS

The invention will be described with reference to the accompanying drawings, wherein like numbers reference like elements.

FIG. 1 is a perspective view (including a block diagram) showing a robot of a robot system according to a first embodiment of the invention.

FIG. 2 is a schematic diagram of the robot shown in FIG. 1.

FIG. 3 is a block diagram showing a main part of the robot system according to the first embodiment.

FIG. 4 is a flowchart for explaining control operation of a robot control device of the robot system according to the first embodiment.

FIG. 5 is a diagram showing a display example displayed on a display device of the robot system according to the first embodiment.

FIG. 6 is a perspective view of the distal end portion of a movable section of the robot of the robot system according to the first embodiment.

FIG. 7 is a perspective view of the distal end portion of the movable section of the robot of the robot system according to the first embodiment.

FIG. 8 is a perspective view of the distal end portion of the movable section of the robot of the robot system according to the first embodiment.

FIG. 9 is a diagram for explaining a coordinate system.

FIG. 10 is a block diagram showing a simulation device according to an embodiment.

FIG. 11 is a perspective view showing a virtual robot displayed on a display device in a simulation of the simulation device shown in FIG. 10.

FIG. 12 is a perspective view of the distal end portion of a virtual movable section of the virtual robot displayed on the display device in the simulation of the simulation device shown in FIG. 10.

FIG. 13 is a perspective view of the distal end portion of the virtual movable section of the virtual robot displayed on the display device in the simulation of the simulation device shown in FIG. 10.

### DESCRIPTION OF EXEMPLARY EMBODIMENTS

A robot control device, a robot control method, a robot system, and a simulation device according to the invention are explained in detail below with reference to embodiments illustrated in the accompanying drawings.

### First Embodiment

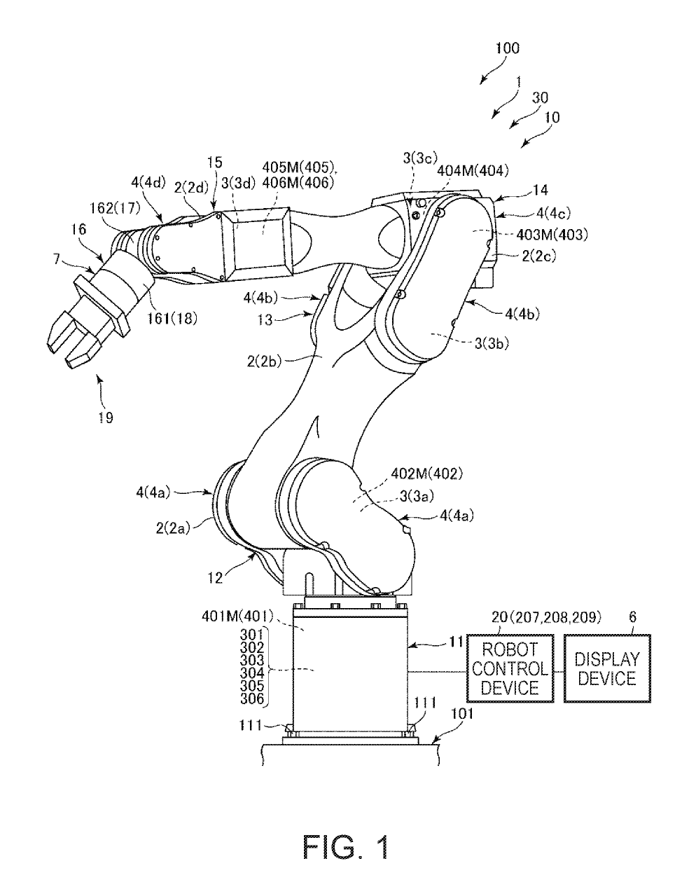

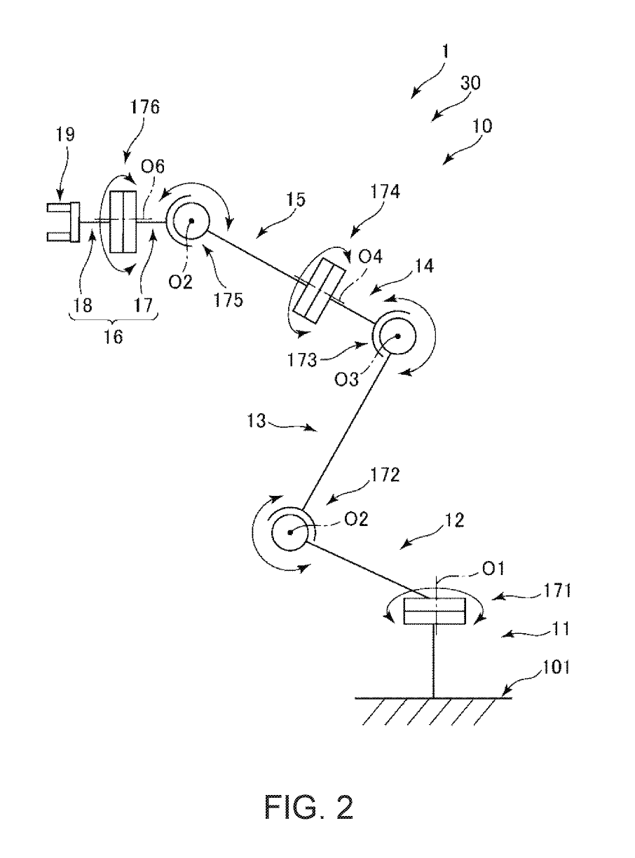

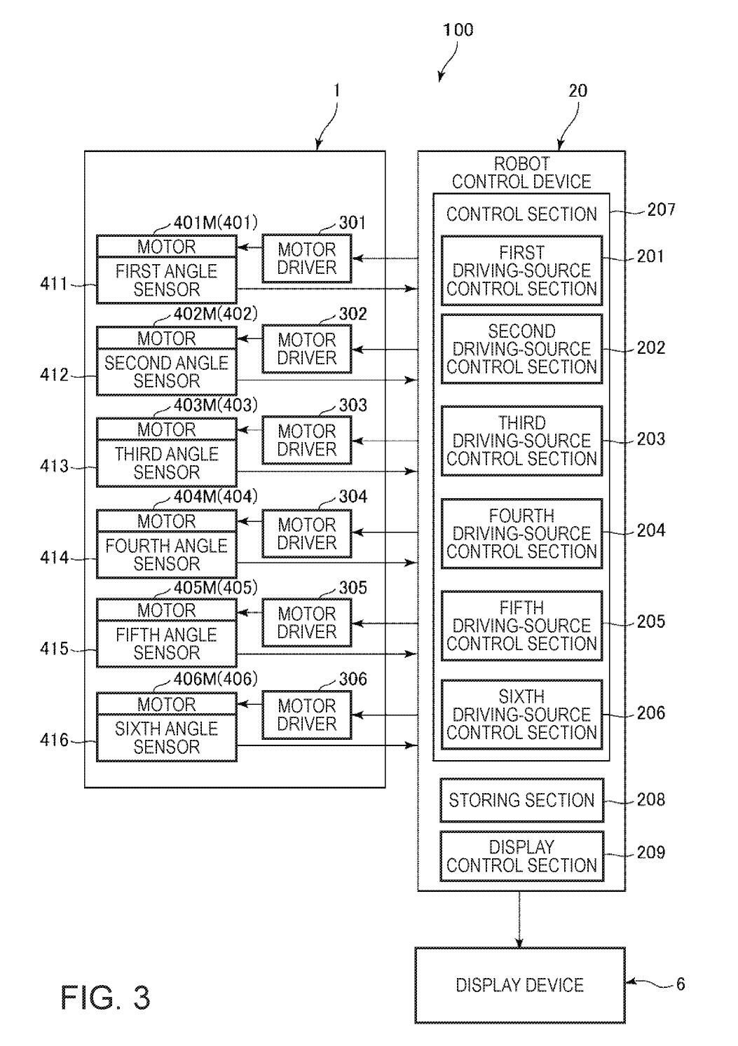

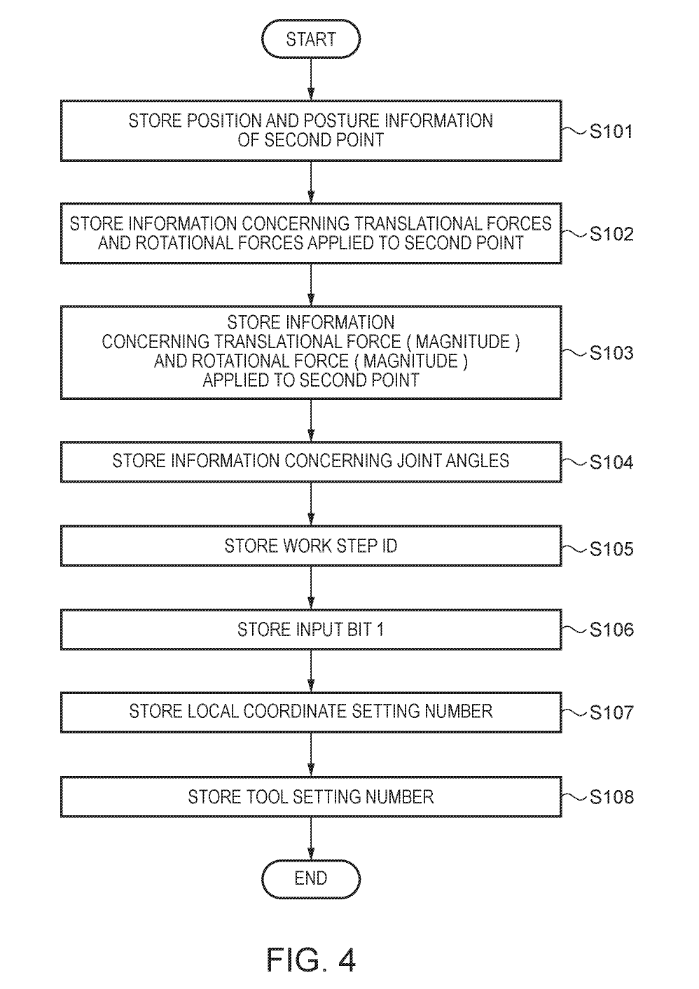

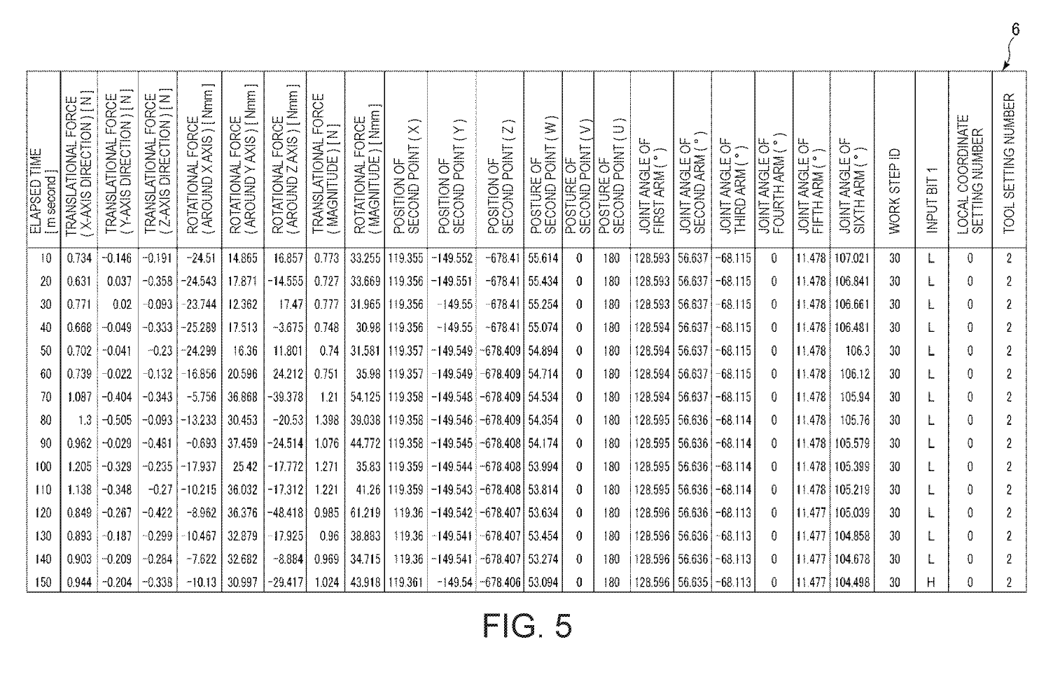

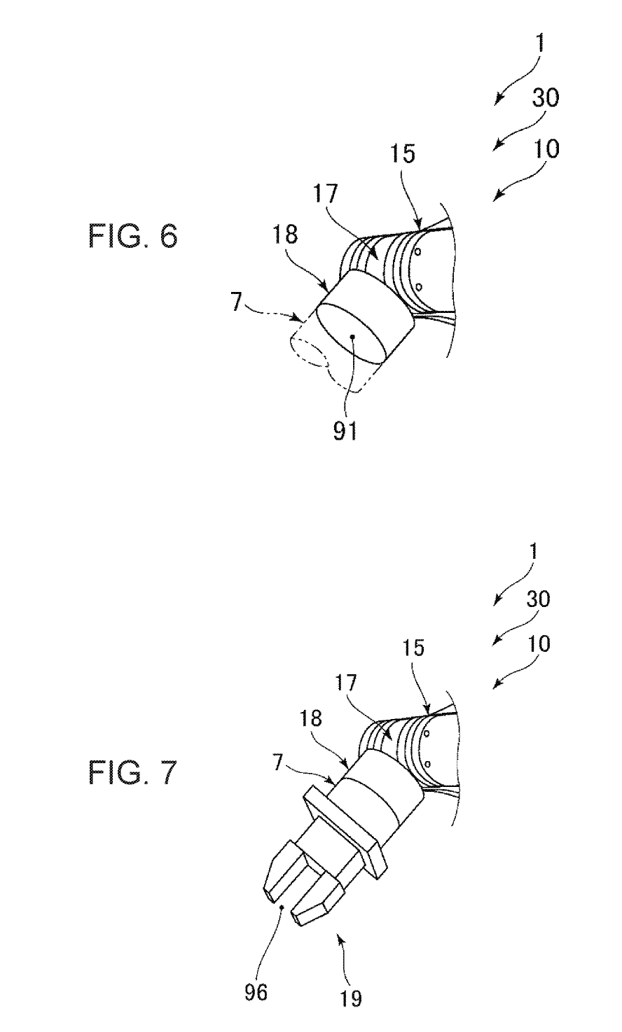

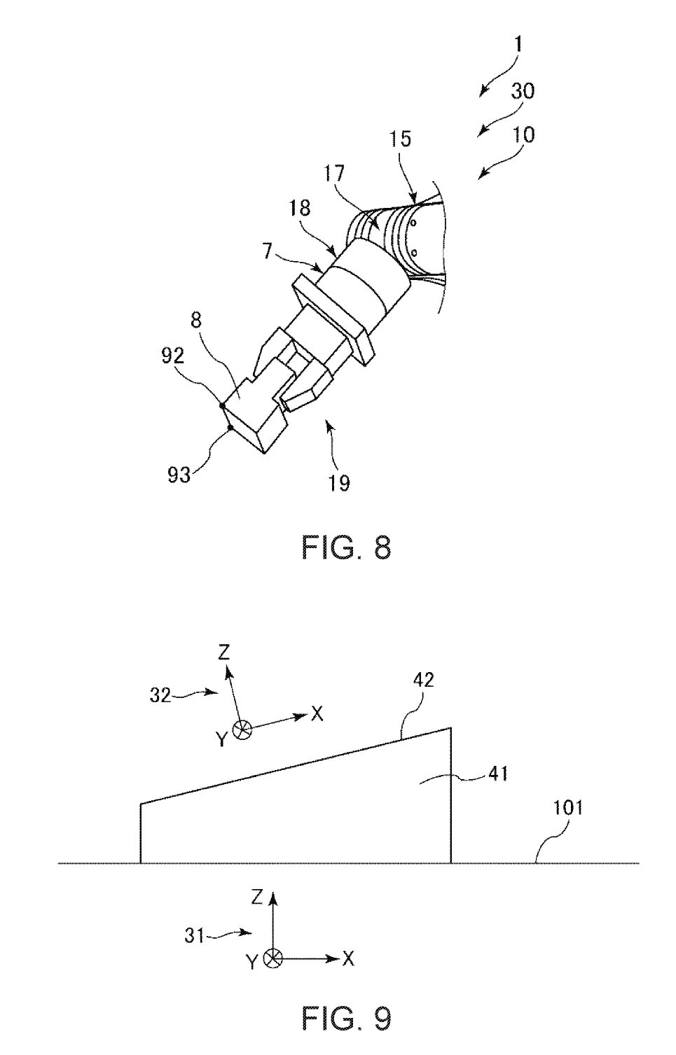

FIG. 1 is a perspective view (including a block diagram) showing a robot of a robot system according to a first embodiment of the invention. FIG. 2 is a schematic diagram of the robot shown in FIG. 1. FIG. 3 is a block diagram showing a main part of the robot system according to the first embodiment. FIG. 4 is a flowchart for explaining control operation of a robot control device of the robot system according to the first embodiment. FIG. 5 is a diagram showing a display example displayed on a display device of the robot system according to the first embodiment. FIG. 6 is a perspective view of a distal end portion of a movable section of the robot of the robot system according to the first embodiment. FIG. 7 is a perspective view of the distal end portion of the movable section of the robot of the robot system according to the first embodiment. FIG. 8 is a perspective view of the distal end portion of the movable section of the robot of the robot system according to the first embodiment. FIG. 9 is a diagram for explaining a coordinate system. Note that, in FIG. 2, illustration of a force detecting device is omitted.

In the following explanation, for convenience of explanation, an upper side in FIGS. 1 and 2 is referred to as “upper” or “upward” and a lower side in FIGS. 1 and 2 is referred to as “lower” or “downward”. A base side in FIGS. 1 and 2 is referred to as “proximal end” or “upstream” and the opposite side of the base side is referred to as “distal end” or “downstream”. An up-down direction in FIGS. 1 and 2 is the vertical direction.

In this specification, “horizontal” includes not only complete horizontality but also inclination within ±5° with respect to the horizontality. Similarly, in this specification, “vertical” includes not only complete verticality but also inclination within ±5° with respect to the verticality. In this specification, “parallel” includes not only mutual complete parallelism of two lines (including axes) or surfaces but also inclination within ±5°. In this specification, “orthogonal” includes not only mutual complete orthogonality of two lines (including axes) or surfaces but also inclination within ±5°.

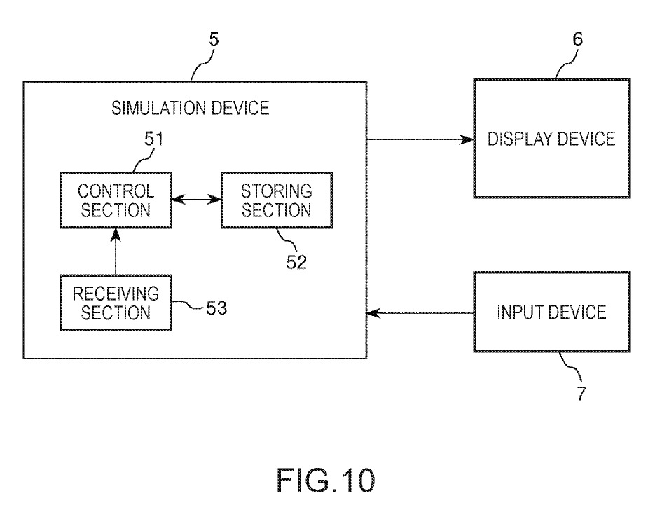

A simulation device 5 shown in FIG. 10 is a device that performs a simulation of operation of a virtual robot 1A on a virtual space, that is, a device that performs operation (control) and the like of the virtual robot 1A including a virtual movable section 30A displayed on a display device 6. In this embodiment, the virtual space is a three-dimensional virtual space but is not limited to this. A robot control device 20 shown in FIG. 3 controls a robot 1 on the basis of a result of the simulation (a simulation result) of the simulation device 5 according to necessity.

Note that signs of sections of the virtual robot 1A are represented by adding “A” after signs of corresponding sections of the actual robot 1. Names of the sections of the virtual robot 1A are respectively represented by adding “virtual” before names of the corresponding sections of the robot 1. Explanation of the virtual robot 1A is substituted by explanation of the robot 1.

A robot system 100 shown in FIGS. 1 and 3 includes the robot 1, the robot control device 20 that controls the robot 1, the display device 6 (a display section), and a not-shown input device (an input section). Uses of the robot system 100 are not particularly limited. The robot system. 100 can be used in various kinds of work such as holding, conveyance, assembly, and inspection of work (objects) such as electronic components and electronic devices.

The robot 1 and the robot control device 20 are electrically connected (hereinafter simply referred to as “connected”) by a cable. The display device 6 and the robot control device 20 are electrically connected by a cable.

Note that the robot 1 and the robot control device 20 are not limited to a wired system. For example, the cable may be omitted. The robot 1 and the robot control device 20 may perform communication in a wireless system. A part or the entire robot control device 20 may be incorporated in the robot 1.

The display device 6 and the robot control device 20 are not limited to the wired system. For example, the cable may be omitted. The display device 6 and the robot control device 20 may perform communication in the wireless system.

The robot control device 20 can be configured by, for example, a computer (PC) incorporating a CPU (Central Processing Unit), which is an example of a processor. The robot control device 20 includes a control section 207 including a first driving-source control section 201 that controls driving (operation) of a first driving source 401 explained below of the robot 1, a second driving-source control section 202 that controls driving of a second driving source 402 explained below of the robot 1, a third driving-source control section 203 that controls driving of a third driving source 403 explained below of the robot 1, a fourth driving-source control section 204 that controls driving of a fourth driving source 404 explained below of the robot 1, a fifth driving-source control section 205 that controls driving of a fifth driving source 405 explained below of the robot 1, and a sixth driving-source control section 206 that controls driving of a sixth driving source 406 explained below of the robot 1 and a storing section 208 that stores various kinds of information.

The control section 207 controls driving of the robot 1, that is, driving of a robot arm 10, an end effector 19, and the like. The control section 207 can be configured by, for example, a computer installed with computer programs (an OS, etc.). That is, the control section 207 includes, for example, a CPU (a processor), a RAM, and a ROM in which computer programs are stored. The function of the control section 207 can be realized by, for example, executing various computer programs with the CPU.

A display control section 209 has a function of causing the display device 6 to display various images (including various screens such as a window), characters, and the like. That is, the display control section 209 controls driving of the display device 6. The function of the display control section 209 can be realized by, for example, a GPU (a processor).

The storing section 208 stores various kinds of information (including data and computer programs). The storing section 208 can be configured by, for example, a semiconductor memory such as a RAM or a ROM, a hard disk device, or an external storage device (not shown in FIGS. 1 and 3).

The display device 6 includes, for example, a monitor (not shown in FIGS. 1 and 3) configured by a liquid crystal display, an EL display, or the like. The display device 6 displays, for example, various images (including various screens such as a window) and characters.

Note that the robot control device 20 is capable of communicating by wire or radio with an input device (not shown in FIGS. 1 and 3) capable of performing various kinds of input operation (inputs) to the robot control device 20. The input device can be configured by, for example, a mouse and a keyboard. A user can give instructions (inputs) of various processing and the like to the robot control device 20 by operating the input device.

As shown in FIGS. 1 and 2, the robot 1 includes a base 11 and the robot arm 10. The robot arm 10 includes a first arm 12, a second arm 13, a third arm 14, a fourth arm 15, a fifth arm 17, and a sixth arm 18 and the first driving source 401, the second driving source 402, the third driving source 403, the fourth driving source 404, the fifth driving source 405, and the sixth driving source 406. A wrist 16 is configured by the fifth arm 17 and the sixth arm 18. The end effector 19 such as a hand can be detachably attached (connected) to the distal end of the sixth arm 18. An object 8 can be gripped (held) by the end effector 19. The object 8 gripped (held) by the end effector 19 is not particularly limited. Examples of the object 8 include various objects such as electronic components and electronic devices.

“The end effector 19 is attached (connected) to the robot arm 10 (the sixth arm 18)” is not limited to direct attachment of the end effector 19 to the robot arm 10 and includes indirect attachment of the end effector 19 to the robot arm 10 such as attachment of the end effector 19 to the force detecting device 7 as in this embodiment.

In this embodiment, the force detecting device 7 (a force detecting section) is detachably attached to the distal end of the sixth arm 18 of the robot arm 10. The end effector 19 is detachably attached (connected) to the force detecting device 7. That is, the force detecting device 7 is provided between the sixth arm 18 and the end effector 19. A movable section 30 is configured by the robot arm 10, the force detecting device 7, and the end effector 19.

Note that the force detecting device 7 is detachably connected to the sixth arm 18. The end effector 19 is detachably connected to the force detecting device 7. However, not only this, but, for example, the force detecting device 7 may be undetachably provided. The force detecting device 7 may be provided on the outside such as a table (not shown on FIGS. 1 and 2) or the like rather than in the robot arm 10 (the movable section 30). In this case, the force detecting device 7 may be detachably provided on the table or may be undetachably provided on the table.

The force detecting device 7 detects a force (including a moment) applied to the end effector 19. The force detecting device 7 is not particularly limited. In this embodiment, for example, a six-axis force sensor capable of detecting force components (translational force components) in axial directions of respective three axes orthogonal to one another and force components (rotational force components) around the respective three axes is used. Note that the force detecting device 7 may be a device having a different configuration.

The robot 1 is a single-arm six-axis vertical articulated robot in which the base 11, the first arm 12, the second arm 13, the third arm 14, the fourth arm 15, the fifth arm 17, and the sixth arm 18 are coupled in this order from the proximal end side toward the distal end side. In the following explanation, the first arm 12, the second arm 13, the third arm 14, the fourth arm 15, the fifth arm 17, the sixth arm 18, and the wrist 16 are respectively referred to as “arms” as well. The first driving source 401, the second driving source 402, the third driving source 403, the fourth driving source 404, the fifth driving source 405, and the sixth driving source 406 are respectively referred to as “driving sources” as well. Note that the lengths of the arms 12 to 15, 17, and 18 are not respectively particularly limited and can be set as appropriate.

The base 11 and the first arm 12 are coupled via a joint 171. The first arm 12 is capable of turning, with respect to the base 11, around a first turning axis O1 parallel to the vertical direction. The first turning axis O1 coincides with the normal of the upper surface of a floor 101, which is a setting surface of the base 11. The first turning axis O1 is a turning axis present on the most upstream side in the robot 1. The first arm 12 turns according to driving of the first driving source 401 including a motor (a first motor) 401M and a reduction gear (not shown in FIGS. 1 and 2). The motor 401M is controlled by the robot control device 20 via a motor driver 301. Note that the reduction gear may be omitted.

The first arm 12 and the second arm 13 are coupled via a joint 172. The second arm 13 is capable of turning, with respect to the first arm 12, around a second turning axis O2 parallel to the horizontal direction. The second turning axis O2 is parallel to an axis orthogonal to the first turning axis O1. The second arm 13 turns according to driving of the second driving source 402 including a motor (a second motor) 402M and a reduction gear (not shown in FIGS. 1 and 2). The motor 402M is controlled by the robot control device 20 via a motor driver 302. Note that the reduction gear may be omitted. The second turning axis O2 may be orthogonal to the first turning axis O1.

The second arm 13 and the third arm 14 are coupled via a joint 173. The third arm 14 is capable of turning, with respect to the second arm 13, around a third turning axis O3 parallel to the horizontal direction. The third turning axis O3 is parallel to the second turning axis O2. The third arm 14 turns according to driving of the third driving source 403 including a motor (a third motor) 403M and a reduction gear (not shown in the figure). The motor 403M is controlled by the robot control device 20 via a motor driver 303. Note that the reduction gear may be omitted.

The third arm 14 and the fourth arm 15 are coupled via a joint 174. The fourth arm 15 is capable of turning, with respect to the third arm 14, around a fourth turning axis O4 parallel to the center axis direction of the third arm 14. The fourth turning axis O4 is orthogonal to the third turning axis O3. The fourth arm 15 turns according to driving of the fourth driving source 404 including a motor (a fourth motor) 404M and a reduction gear (not shown in FIGS. 1 and 2). The motor 404M is controlled by the robot control device 20 via a motor driver 304. Note that the reduction gear may be omitted. The fourth turning axis O4 may be parallel to an axis orthogonal to the third turning axis O3.

The fourth arm 15 and the fifth arm 17 of the wrist 16 are coupled via a joint 175. The fifth arm 17 is capable of turning around a fifth turning axis O5 with respect to the fourth arm 15. The fifth turning axis O5 is orthogonal to the fourth turning axis O4. The fifth arm 17 turns according to driving of the fifth driving source 405 including a motor (a fifth motor) 405M and a reduction gear (not shown in FIGS. 1 and 2). The motor 405M is controlled by the robot control device 20 via a motor driver 305. Note that the reduction gear may be omitted. The fifth turning axis O5 may be parallel to an axis orthogonal to the fourth turning axis O4.

The fifth arm 17 of the wrist 16 and the sixth arm 18 are coupled via a joint 176. The sixth arm 18 is capable of turning around a sixth turning axis O6 with respect to the fifth arm 17. The sixth turning axis O6 is orthogonal to the fifth turning axis O5. The sixth arm 18 turns according to driving of the sixth driving source 406 including a motor (a sixth motor) 406M and a reduction gear (not shown in FIGS. 1 and 2). The motor 406M is controlled by the robot control device 20 via a motor driver 306. Note that the reduction gear may be omitted. The sixth turning axis O6 may be parallel to an axis orthogonal to the fifth turning axis O5.

Note that the wrist 16 includes, as the sixth arm 18, a wrist body 161 formed in a cylindrical shape. The wrist 16 includes, as the fifth arm 17, a support ring 162 configured separately from the wrist body 161, provided at the proximal end portion of the wrist body 161, and formed in a ring shape.

In the driving sources 401 to 406, a first angle sensor 411, a second angle sensor 412, a third angle sensor 413, a fourth angle sensor 414, a fifth angle sensor 415, and a sixth angle sensor 416 are provided in the motors or the reduction gears of the driving sources 401 to 406. The angle sensors are not particularly limited. For example, an encoder such as a rotary encoder can be used. Rotation (turning) angles of rotation axes (turning axes) of the motors or the reduction gears of the driving sources 401 to 406 are respectively detected by the angle sensors 411 to 416.

The motors of the driving sources 401 to 406 are not respectively particularly limited. For example, a servomotor such as an AC servomotor or a DC servomotor is desirably used.

The robot 1 is electrically connected to the robot control device 20. That is, the driving sources 401 to 406 and the angle sensors 411 to 416 are respectively electrically connected to the robot control device 20.

The robot control device 20 can operate the arms 12 to 15 and the wrist 16 independently from one another. That is, the robot control device 20 can control the driving sources 401 to 406 independently from one another via the motor drivers 301 to 306. In this case, the robot control device 20 performs detection with the angle sensors 411 to 416 and the force detecting device 7 and respectively controls driving of the driving sources 401 to 406, for example, angular velocities and rotation angles on the basis of results of the detection (detection information). A computer program for the control is stored in advance in the storing section 208 of the robot control device 20.

In this embodiment, the base 11 is a portion located in the bottom in the vertical direction of the robot 1 and fixed to (set in) the floor 101 or the like of a setting space. A method of fixing the base 11 is not particularly limited. For example, in this embodiment, a fixing method by a plurality of bolts 111 is used. The floor 101 of a portion to which the base 11 is fixed is a plane (a surface) parallel to the horizontal plane. However, the floor 101 is not limited to this.

In the base 11, for example, the motor 401M and the motor drivers 301 to 306 are housed.

The arms 12 to 15 respectively include hollow arm bodies 2, driving mechanisms 3 housed in the arm bodies 2 and including motors, and sealing sections 4 configured to seal the insides of the arm bodies 2. Note that, in FIG. 1, the arm body 2, the driving mechanism 3, and the sealing section 4 included in the first arm 12 are respectively represented as “2a”, “3a”, and “4a” as well. The arm body 2, the driving mechanism 3, and the sealing section 4 included in the second arm 13 are respectively represented as “2b”, “3b”, and “4b” as well. The arm body 2, the driving mechanism 3, and the sealing section 4 included in the third arm 14 are respectively represented as “2c”, “3c”, and “4c” as well. The arm body 2, the driving mechanism 3, and the sealing section 4 included in the fourth arm 15 are respectively represented as “2d”, “3d”, and “4d” as well.

Control of the robot 1 by the robot control device 20 is explained.

The control section 207 of the robot control device 20 controls the driving of the robot 1. When the robot 1 operates, the control section 207 calculates various kinds of information (log record items) of the robot 1 and stores the information (the log record items) in the storing section 208. The storage of the information is repeatedly performed at a predetermined time interval, in this embodiment, at a fixed time interval.

Examples of the information (the log record items) stored in the storing section 208 include position and posture information of a second point 92 (see FIG. 8) of the object 8, position and posture information of a control point 96 (a tool control point) (see FIG. 7), information concerning a force applied to the second point 92 of the object 8, information concerning a joint flag, a work step ID, input and output information (e.g., an input bit 1), a local coordinate setting number, and a tool setting number.

Specific examples include, in this embodiment, as shown in FIG. 5, a translational force (in an X-axis direction) [N], a translational force (in a Y-axis direction) [N], and a translational force (in a Z-axis direction) [N], a rotational force (around an X axis) [N·mm], a rotational force (around a Y axis) [N·mm], and a rotational force (around a Z axis) [N·mm], and a translational force (magnitude) [N] and a rotational force (magnitude) [N·mm] applied to the second point 92, a position (X) of the second point 92, a position (Y) of the second point 92, and a position (Z) of the second point 92, a posture (W: around the X axis) of the second point 92, a posture (V: around the Y axis) of the second point 92, and a posture (U: around the Z axis) of the second point 92, a joint angle (arm joint angle) [°] of the first arm 12, a joint angle [°] of the second arm 13, a joint angle [°] of the third arm 14, a joint angle [°] of the fourth arm 15, a joint angle [°] of the fifth arm 17, and a joint angle [°] of the sixth arm 18, information (not shown in FIG. 5) of a joint flag, a work step ID, an input bit 1, a local coordinate setting number, and a tool setting number. These kinds of information are stored in association with an elapsed time. Note that, in this specification, a direction around the X axis is represented as a W-axis direction, a direction around the Y axis is represented as a V-axis direction, and a direction around the Z axis is represented as a U-axis direction. A posture at the control point 96 is represented by a relation among a roll (a U axis), a pitch (a V axis), and a yaw (a W axis). These are respectively sometimes simplified and represented by only alphabets.

Predetermined information among the information of the robot 1 stored in the storing section 208 is displayed on the display device 6 according to necessity. A form of the display is not particularly limited. In this embodiment, as shown in FIG. 5, the information is displayed as a list (as a table) in association with an elapsed time.

First, as shown in FIGS. 6 to 8, a first point 91, the second point 92, and the control point 96 are set in the movable section 30 of the robot 1.

The first point 91 only has to be any point (portion) in the robot arm 10. In this embodiment, the first point 91 is set in, for example, the center of the distal end of the sixth arm 18.

The second point 92 only has to be any point (portion) in the object 8. The second point 92 is set independently from the control point 96. Consequently, when the control point 96 is changed, although position and posture information of the control point 96 is changed, position and posture information of the second point 92 is not changed. Consequently, it is possible to accurately grasp the operation performed by the robot 1. In this embodiment, the second point 92 is set at, for example, a corner portion of the distal end of the object 8. Note that examples other than the corner portion of the setting part of the second point 92 include the center of the distal end of the object 8. In this embodiment, one second point 92 is set. However, a plurality of second points 92 may be set.

The control point 96 (the tool control point) only has to be any point (portion) in the end effector 19. In this embodiment, the control point 96 is set in, for example, the center of the distal end of the end effector 19.

The position and posture information of the first point 91 refers to information including information concerning the position of the first point 91, that is, information concerning a position in the X-axis direction (a coordinate of the X axis), a position in the Y-axis direction (a coordinate of the Y axis), and a position in the Z-axis direction (a coordinate of the Z axis) and information concerning the posture of the first point 91, that is, a position in the U-axis direction (a rotation angle around the Z axis), a position in the V-axis direction (a rotation angle around the Y axis), and a position in the W-axis direction (a rotation angle around the X axis). The same applies to the position and posture information of the second point 92, the position and posture information of the control point 96, and position and posture information of a third point 93 explained below.

The position and posture information of the first point 91 can be calculated by forward kinetics on the basis of a joint angle of the first arm 12, a joint angle of the second arm 13, a joint angle of the third arm 14, a joint angle of the fourth arm 15, a joint angle of the fifth arm 17, and a joint angle of the sixth arm 18. The same applies to the position and posture information of the control point 96.

Relative position and posture information of the second point 92 with respect to the first point 91 refers to information including information concerning a position of the second point 92 at the time when the position of the first point 91 is set as a reference (an origin) (a relative position of the second point 92 with respect to the first point 91), that is, information concerning a position in the X-axis direction, a position in the Y-axis direction, and a position in the Z-axis direction of the second point 92 and information concerning a posture of the second point 92 at the time when the posture of the first point 91 is set as a reference (an origin) (a relative posture of the second point 92 with respect to the first point 91), that is, information concerning a position in the U-axis direction, a position in the V-axis direction, and a position in the W axis direction of the second point 92.

The relative position and posture information of the second point 92 with respect to the first point 91 (hereinafter simply referred to as “relative position and posture information of the second point 92” as well) is known information and stored in the storing section 208 in advance. Consequently, the position and posture information of the second point 92 can be calculated on the basis of the position and posture information of the first point 91 and the relative position and posture information of the second point 92. When the robot 1 operates, the control section 207 calculates, on the basis of position and posture information of the first point 91 of the robot arm 10 and relative position and posture information of the second point 92 of the object 8 with respect to the first point 91, position and posture information of the second point 92.

The position and posture information of the first point 91, the position and posture information of the second point 92, and the relative position and posture information of the second point 92 are respectively calculated on the basis of a base coordinate system 31 shown in FIG. 9. The base coordinate system 31 is a three-dimensional local coordinate system including an X axis and a Y axis parallel to the floor 101 on which the base 11 of the robot 1 is set and a Z axis orthogonal to the floor 101. The position of the origin of the base coordinate system 31 is not particularly limited. The position of the origin is set in, for example, the center of the lower end face of the base 11 (in FIG. 9, the base coordinate system 31 is illustrated in another position).

The position and posture information of the first point 91, the position and posture information of the second point 92, and the relative position and posture information of the second point 92 may be respectively calculated on the basis of a local coordinate system 32 shown in FIG. 9 different from the base coordinate system 31. The local coordinate system 32 is a three-dimensional coordinate system including an X axis and a Y axis parallel to a work surface 42 of a workbench 41 on which the robot 1 performs work and a Z axis orthogonal to the work surface 42. The position of the original of the local coordinate system 32 is not particularly limited. The position of the origin is set in, for example, the center of the work surface 42 of the workbench 41 (in FIG. 9, the base coordinate system 31 is illustrated in another position). This configuration is effective, for example, when the work surface 42 of the workbench 41 is inclined with respect to the floor 101. Note that, when there are a plurality of workbenches and work surfaces of the workbenches have different inclination angles, local coordinate systems may be set on the respective work surfaces.

Examples of the information concerning the joint flag include “J1Flag”, which is a flag (information) concerning a joint of the first arm 12, “J4Flag”, which is a flag (information) concerning a joint of the fourth arm 15, and “J6Flag”, which is a flag (information) concerning a joint of the sixth arm 18. The information concerning the joint flag is desirably displayed as a list (as a table) in association with an elapsed time, although not shown in FIG. 5.

As an example, when the joint angle of the first arm 12 is larger than −90° and equal to or smaller than 270°, the J1Flag is set to “0” and, when the joint angle of the first arm 12 is larger than −270° and equal to or smaller than −90° or larger than 270° and equal to or smaller than 450°, the J1Flag is set to “1”.

When the joint angle of the fourth arm 15 is larger than −180° and equal to or smaller than 180°, J4Flag is set to “0” and, when the joint angle of the fourth arm 15 is equal to or smaller than −180° or larger than 180°, J4Flag is set to “1”.

When the joint angle of the sixth arm 18 is larger than −180° and equal to or smaller than 180°, J6Flag is set to “0” and, when the joint angle of the sixth arm 18 is larger than −360° and equal to or smaller than −180° or larger than 180° and equal to or smaller than 360°, J6Flag is set to “1”.

The work step ID is a sign for identifying work and a process of the work performed by the robot 1.

The local coordinate setting number is a number that is, when a plurality of local coordinates are stored in the storing section 208 (in some case, a single local coordinate is stored), associated with the local coordinates in order to specify (select) a predetermined local coordinate out of the local coordinates.

The tool setting number is a number that is, when a plurality of tools are stored in the storing section 208 (in some case, a single tool is stored), associated with the tools in order to specify (select) a predetermined tool out of the tools. A tool coordinate is a coordinate set in the movable section 30. In the tool coordinate, the first point 91 is set as a reference and a point to which a position and a posture shift from the first point 91 is set as an origin.

A robot control method is explained. Control of the robot 1 by the robot control device 20 is explained with reference to a flowchart of FIG. 4.

First, the robot control method includes, when the robot 1 operates, calculating position and posture information of the second point 92 on the basis of the position and posture information of the first point 91 of the robot arm 10 and the relative position and posture information of the second point 92 of the object 8 with respect to the first point 91 and causing the storing section 208 to store the position and posture information of the second point 92. As explained above, the position and posture information of the second point 92 stored in the storing section 208 is displayed on the display device according to necessity together with other information concerning the robot 1 stored in the storing section 208.

Control of the robot 1 by the control section 207 of the robot control device 20 at the time when the robot 1 operates is explained.

As shown in FIG. 4, first, the control section 207 calculates, on the basis of the position and posture information of the first point 91 of the robot arm 10 and the relative position and posture information of the second point 92 of the object 8 with respect to the first point 91, position and posture information of the second point 92 and stores the position and posture information of the second point 92 in the storing section 208 (step S101). The position and posture information of the second point 92 is a position (X) of the second point 92, a position (Y) of the second point 92, and a position (Z) of the second point 92 and a posture (X) of the second point 92, a posture (Y) of the second point 92, and a posture (Z) of the second point 92.

Subsequently, the control section 207 calculates, on the basis of force information detected by the force detecting device 7, a translational force (in the X-axis direction), a translational force (in the Y-axis direction), and a translational force (in the Z-axis direction) and a rotational force (around the X axis), a rotational force (around the Y axis), and a rotational force (around the Z axis) applied to the second point 92 and stores information concerning the translational forces and the rotational forces (information concerning forces) in the storing section 208 (step S102).

Subsequently, the control section 207 calculates, on the basis of the force information detected by the force detecting device 7, a translational force (magnitude) and a rotational force (magnitude) applied to the second point 92 and stores information concerning the translational force and the rotational force (information concerning forces) in the storing section 208 (step S103).

Subsequently, the control section 207 calculates a joint angle of the first arm 12, a joint angle of the second arm 13, a joint angle of the third arm 14, a joint angle of the fourth arm 15, a joint angle of the fifth arm 17, and a joint angle of the sixth arm 18 on the basis of angle information detected by the first angle sensor 411, the second angle sensor 412, the third angle sensor 413, the fourth angle sensor 414, the fifth angle sensor 415, and the sixth angle sensor 416 and stores information concerning the joint angles in the storing section 208 (step S104).

Subsequently, the control section 207 stores the work step ID in the storing section 208 (step S105).

Subsequently, the control section 207 stores the input bit 1 in the storing section 208 (step S106).

Subsequently, the control section 207 stores the local coordinate setting number in the storing section 208 (step S107).

Subsequently, the control section 207 stores the tool setting number in the storing section 208 (step S108).

Steps S101 to S108 are repeatedly performed at a fixed time interval while the robot 1 is operating.

Note that the order of steps S101 to S108 is not limited to the order described above and can be changed.

A step in which the control section 207 stores the information concerning the joint flag in the storing section 208 may be provided.

As shown in FIG. 5, the information stored in the storing section 208 is displayed on the display device 6 as a list in association with an elapsed time according to control by the display control section 209. Consequently, because the position and posture information of the second point 92 is displayed, it is possible to easily and quickly grasp the operation performed by the robot 1. In particular, a person unfamiliar with robotics can easily and quickly grasp the operation performed by the robot 1 because the position and posture information of the second point 92 is based on the shape and the like of the object 8 compared with the position and posture information of the control point 96. Note that the display may be performed by the user operating a not-shown input device or may be automatically performed.

The robot control device 20 is configured to be capable of performing control explained below other than normal control in the control of the robot 1.

That is, the control section 207 of the robot control device 20 controls the driving of the robot 1 on the basis of predetermined information among the information stored in the storing section 208. Specific configuration examples are explained below.

### Configuration 1

The control section 207 controls the driving of the robot 1 on the basis of joint angle information of the robot arm 10 stored in the storing section 208. Consequently, it is possible to easily and accurately reproduce the operation performed by the robot 1.

### Configuration 2

The control section 207 calculates position and posture information of the third point 93 shown in FIG. 8 different from the second point 92 on the basis of the position and posture information of the second point 92 and the joint angle information of the robot arm 10. The control section 207 stores the position and posture information of the third point 93 in the storing section 208. The position and posture information of the third point 93 can be used, for example, when the operation performed by the robot 1 is grasped and when the operation performed by the robot 1 is reproduced. Note that the third point 93 is not limited to one point and may be a plurality of points.

### Configuration 3

In the control of the robot 1 by the control section 207, when the robot 1 operates, the control section 207 may further calculate position and posture information of the control point 96 and store the position and posture information of the control point 96 in the storing section 208.

In the configuration 3, the control section 207 is capable of controlling the driving of the robot 1 on the basis of the position and posture information of the control point 96 stored in the storing section 208. Therefore, the control section 207 controls the driving of the robot 1 on the basis of the position and posture information of the control point 96 stored in the storing section 208. Consequently, it is possible to easily and accurately reproduce the operation performed by the robot 1.

### Configuration 4

The control section 207 controls the driving of the robot 1 on the basis of the position and posture information of the control point 96 stored in the storing section 208 and the information concerning the joint flag of the robot arm 10. Consequently, it is possible to easily and accurately reproduce the operation performed by the robot 1.

Note that the configuration for using the information concerning the joint flag of the robot arm 10 in the control of the driving of the robot 1 can be applied to other configurations.

As explained above, with the robot system 100 (the robot control device 20), the information including the position and posture information of the second point 92 is displayed on the display device 6. Consequently, it is possible to easily and quickly grasp the operation performed by the robot 1. In particular, a person unfamiliar with robotics can easily grasp the position and posture information of the second point 92 compared with the position and posture information of the control point 96. Consequently, it is possible to easily and quickly grasp the operation performed by the robot 1.

As explained above, the robot control device 20 includes the control section 207 that controls the robot 1 including the movable section 30 including the robot arm 10, the end effector 19 detachably attached to the robot arm 10 and configured to hold the object 8, and the force detecting device 7.

When the robot 1 (the robot arm 10) operates, the control section 207 calculates, on the basis of the position and posture information of the first point 91 of the robot arm 10 and the relative position and posture information of the second point 92 of the object 8 with respect to the first point 91, position and posture information of the second point 92 and causes the storing section 208 to store the position and posture information of the second point 92.

With such a robot control device 20, it is possible to easily and quickly grasp, with the position and posture information of the second point 92, the operation performed by the robot 1.

When the robot 1 operates, the control section 207 calculates, on the basis of force information detected by the force detecting device 7, a force applied to the second point 92 and causes the storing section 208 to store information concerning the force applied to the second point 92. Consequently, it is possible to grasp the force applied to the second point 92.

The robot control device 20 includes the display control section 209 that controls driving of the display device 6. The display control section 209 causes the display device 6 to display, as a list, the position and posture information of the second point 92 stored in the storing section 208 and the information concerning the force applied to the second point 92 stored in the storing section 208. Consequently, by viewing the information displayed on the display device 6, it is possible to easily and quickly grasp the operation performed by the robot 1 and a force applied to the movable section 30 in the operation.

The second point 92 is set independently from the control point 96 set in the end effector 19. Consequently, when the control point 96 is changed, the position and posture information of the control point 96 is changed but the position and posture information of the second point 92 is not changed. Therefore, it is possible to accurately grasp the operation performed by the robot 1.

The position and posture information of the second point 92 is calculated on the basis of the local coordinate system 32 different from the base coordinate system 31 of the robot 1. Consequently, it is possible to easily grasp the position and the posture of the second point 92.

The control section 207 calculates position and posture information of the third point 93 on the basis of the position and posture information of the second point 92 and the joint angle information of the robot arm 10. Consequently, it is possible to more easily and quickly grasp the operation performed by the robot 1.

When the robot 1 operates, the control section 207 causes the storing section 208 to store the position and posture information of the control point 96 set in the end effector 19 and controls the robot 1 on the basis of the position and posture information of the control point 96 stored in the storing section 208. Consequently, when the robot 1 is operated, it is possible to easily reproduce at least a part of the operation.

When the robot 1 operates, the control section 207 causes the storing section 208 to store the joint angle information of the robot arm 10 and controls the robot 1 on the basis of the joint angle information of the robot arm 10 stored in the storing section 208. Consequently, when the robot 1 is operated, it is possible to easily reproduce at least a part of the operation.

When the robot 1 operates, the control section 207 causes the storing section 208 to store the information concerning the joint flag and controls the robot 1 on the basis of the information concerning the joint flag stored in the storing section 208. Consequently, when the robot 1 is operated, it is possible to easily reproduce at least a part of the operation.

The robot control method is a robot control method for controlling the robot 1 including the movable section 30 including the robot arm 10, the end effector 19 detachably attached to the robot arm 10 and configured to hold the object 8, and the force detecting device 7.

The robot control method includes, when the robot 1 operates, calculating position and posture information of the second point 92 on the basis of the position and posture information of the first point 91 of the robot arm 10 and the relative position and posture information of the second point 92 of the object 8 with respect to the first point 91 and causing the storing section 208 to store the position and posture information of the second point 92.

With such a robot control method, it is possible to easily and quickly grasp, with the position and posture information of the second point 92, the operation performed by the robot 1.

The robot system 100 includes the robot 1 including the movable section 30 including the robot arm 10, the end effector 19 detachably attached to the robot arm 10 and configured to hold the object 8, and the force detecting device 7 and the robot control device 20 that controls the robot 1.

With such a robot system 100, it is possible to easily and quickly grasp, with the position and posture information of the second point 92, the operation performed by the robot 1.

### Simulation Device According to an Embodiment

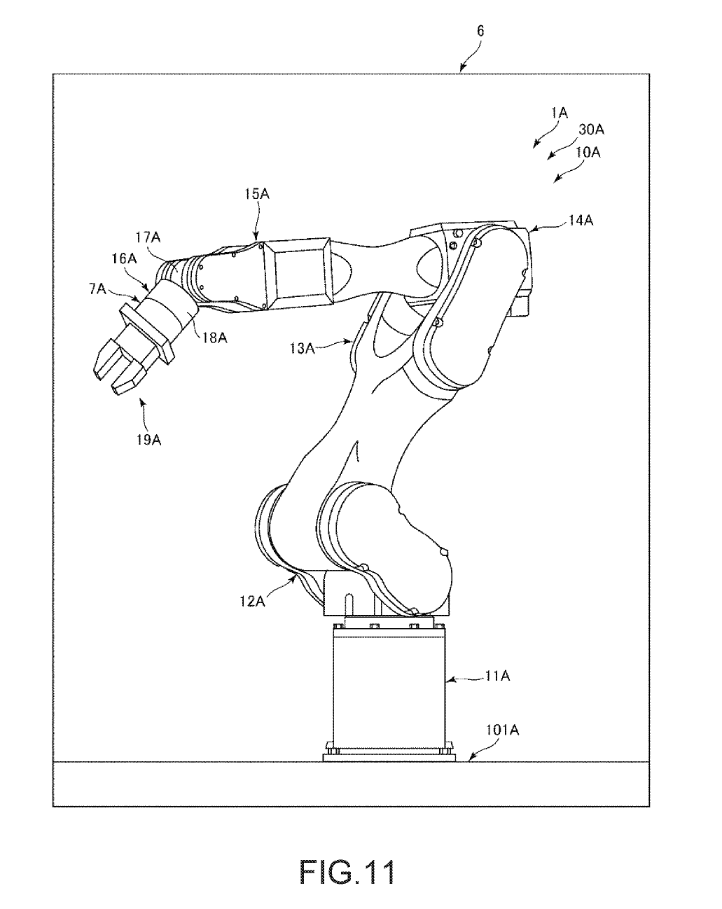

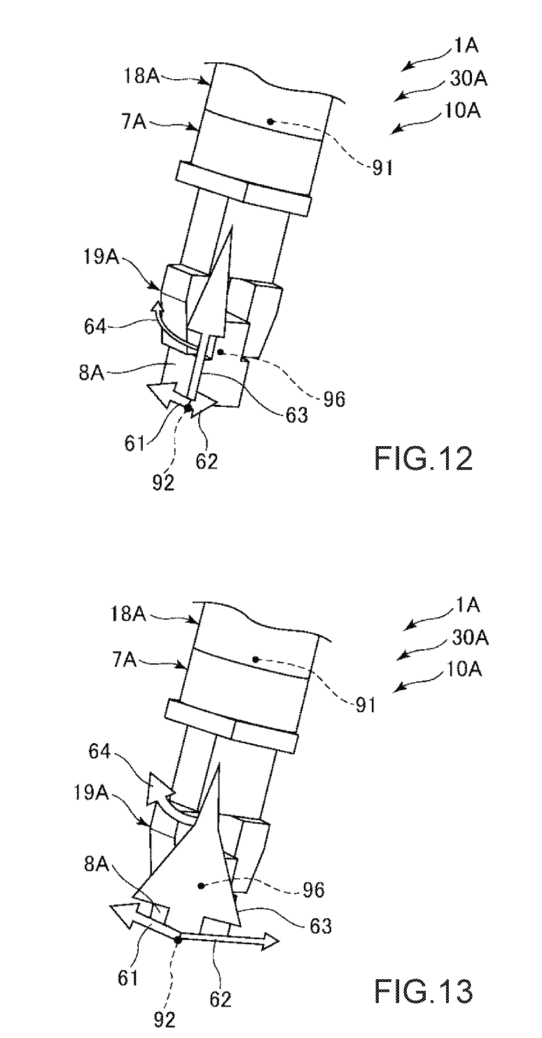

FIG. 10 is a block diagram showing a simulation device according to an embodiment of the invention. FIG. 11 is a perspective view showing a virtual robot displayed on the display device in a simulation of the simulation device shown in FIG. 10. FIG. 12 is a perspective view of the distal end portion of a virtual movable section of the virtual robot displayed on the display device in the simulation of the simulation device shown in FIG. 10. FIG. 13 is a perspective view of the distal end portion of the virtual movable section of the virtual robot displayed on the display device in the simulation of the simulation device shown in FIG. 10.

The simulation device according to this embodiment is explained below. Differences from the first embodiment explained above are mainly explained. Explanation of similarities is omitted.

First, the virtual robot 1A is briefly explained.

As shown in FIG. 11, the virtual robot 1A is the same as the robot 1 explained above. The virtual robot 1A includes a virtual base 11A set on (fixed to) a virtual floor 101A and a virtual robot arm 10A. The virtual robot arm 10A includes a turnably provided plurality of arms, in this embodiment, a virtual first arm 12A, a virtual second arm 13A, a virtual third arm 14A, a virtual fourth arm 15A, a virtual fifth arm 17A, and a virtual sixth arm 18A. A virtual wrist 16A is configured by the virtual fifth arm 17A and the virtual sixth arm 18A. The virtual robot arm 10A includes a plurality of driving sources that drive these arms, in this embodiment, six driving sources (not shown in FIG. 11).

In this embodiment, a virtual force detecting device 7A is detachably attached (connected) to the distal end of the virtual sixth arm 18A of the virtual robot arm 10A. A virtual end effector 19A is detachably attached (connected) to the virtual force detecting device 7A. A virtual movable section 30A is configured by the virtual robot arm 10A, the virtual force detecting device 7A, and the virtual end effector 19A. In such a virtual movable section 30A, a virtual object 8A can be grasped (held) by the virtual end effector 19A.

The simulation device 5 can be configured by, for example, a computer (PC) incorporating a CPU (Central Processing Unit), which is an example of a processor. As shown in FIG. 10, the simulation device 5 includes a control section 51 that performs various kinds of control, a storing section 52 that stores various kinds of information, and a receiving section 53. The simulation device 5 is a device that performs operation and the like (a simulation) of the virtual robot 1A on a virtual space displayed on the display device 6. The simulation device 5 controls the driving of the virtual robot 1A on the virtual space.

The control section 51 has a function of causing the display device 6 to display various kinds of images (including various screens such as a window besides an image of the virtual robot 1A) or characters. The control section 51 controls, for example, the driving of the virtual robot 1A, that is, driving of the virtual robot arm 10A, the virtual end effector 19A, and the like. The control section 51 can be configured by, for example, a computer or a GPU installed with computer programs (an OS, etc.). That is, the control section 51 includes, for example, a CPU (a processor), a GPU (a processor), a RAM, and a ROM in which computer programs are stored. The function of the control section 51 can be realized by, for example, executing various computer programs with the CPU.

The storing section 52 stores various kinds of information (including data and computer programs). The storing section 52 can be configured by, for example, a semiconductor memory such as a RAM or a ROM, a hard disk device, or an external storage device.

The receiving section 53 receives inputs such as an input from an input device 21 (an input section). The receiving section 53 can be configured by, for example, an interface circuit.

The simulation device 5 is capable of communicating by wire or radio with the display device 6 capable of displaying images such as an image showing a simulation. Note that the display device 6 is the same as the display device 6 in the first embodiment. Therefore, explanation of the display device 6 is omitted.

The simulation device 5 is capable of communicating by wire or radio with the input device 21 capable of performing various kinds of input operation (inputs) to the simulation device 5. The input device 21 can be configured by, for example, a mouse and a keyboard. The user can give an instruction (an input) of various kinds of processing and the like to the simulation device 5 by operating the input device 21.

Specifically, the user can give an instruction to the simulation device 5 through operation for clicking, with the mouse of the input device 21, various screens (a window, etc.) displayed on the display device 6 or operation for inputting characters, numbers, and the like with the keyboard of the input device 21.

The display device 6 and the input device 21 are separate bodies. However, not only this, but the display device 6 may include the input device 21. That is, instead of the display device 6 and the input device 21, a display input device (not shown in FIG. 10) including the display device 6 and the input device 21 may be provided. As the display input device 21, for example, a touch panel (an electrostatic touch panel or a pressure sensitive touch panel) can be used. Consequently, it is unnecessary to separately prepare the input device 21 besides the display device 6. Therefore, convenience is high.

A simulation system is configured by the simulation device 5, the display device 6, and the input device 21. Note that the simulation device 5 may include a display device (a display section) instead of the display device 6. The simulation device 5 may include a display device (a display section) separately from the display device 6. The simulation device 5 may include an input device 21 (an input section) instead of the input device 21. The simulation device 5 may include an input device (an input section) separately from the input device 21.

A simulation performed by such a simulation device is the same as the control (the operation) explained concerning the robot control device 20 and the robot 1. The simulation of the simulation device 5 is displayed on the display device 6. Specific configuration examples are briefly explained below.

### Configuration 1

The control section 51 of the simulation device 5 controls driving (performs operation) of the virtual robot 1A on the virtual space displayed on the display device 6. When the virtual robot 1A operates, the control section 51 calculates various kinds of information (log record items) of the virtual robot 1A and stores the information (the log record items) in the storing section 52. The storage of the information is repeatedly performed at a predetermined time interval, in this embodiment, at a fixed time interval. Note that the information (the log record items) stored in the storing section 52 is, for example, the same as the information (the log record items) in the case of the robot 1 explained above. The information is stored in association with an elapsed time.

Predetermined information among the information of the virtual robot 1A stored in the storing section 52 is displayed on the display device 6 according to necessity. A form of the display is not particularly limited. In this embodiment, the information is displayed as a list in association with an elapsed time. Consequently, because the position and posture information of the second point 92 is displayed, it is possible to easily and quickly grasp the operation performed by the virtual robot 1A. In particular, a person unfamiliar with robotics can easily grasp the position and posture information of the second point 92 compared with the position and posture information of the control point 96. Consequently, it is possible to easily and quickly grasp the operation performed by the virtual robot 1A.

### Configuration 2

The control section 51 controls the driving of the virtual robot 1A on the basis of information concerning joint angles of the virtual robot arm 10A stored in the storing section 52. Consequently, it is possible to easily and accurately reproduce, in the simulation, the operation performed by the virtual robot 1A.

### Configuration 3

The control section 51 calculates position and posture information of the third point 93 on the basis of the position and posture information of the second point 92 and the information concerning the joint angles of the virtual robot arm 10A. The control section 51 stores the position and posture information of the third point 93 in the storing section 52. The position and posture information of the third point 93 can be used, for example, when the operation performed by the virtual robot 1A is grasped and when the operation performed by the virtual robot 1A is reproduced. Note that the third point 93 is not limited to one point and may be a plurality of points.

### Configuration 4

As explained above, when the virtual robot 1A operates, the control section 51 stores, in the storing section 52, information concerning forces applied to a predetermined portion of the virtual movable section 30A, for example, forces applied to the second point 92. When reproducing the operation performed by the virtual robot 1A, the control section 51 causes the display device 6 to display, as arrows 61, 62, 63, and 64, together with the virtual robot 1A, the information concerning the forces stored in the storing section 52 (see FIGS. 12 and 13). In this case, the arrow 61 indicates a translational force in the X-axis direction, the arrow 62 indicates a translational force in the Y-axis direction, the arrow 63 indicates a translational force in the Z-axis direction, and the arrow 64 indicates a rotational force around the Z axis. In a configuration example shown in FIG. 12, the directions of the arrows 61 to 64 are the directions of the forces. The sizes of the arrows 61 to 64, specifically, the lengths of the arrows 61 to 64 correspond to the magnitudes of the forces. In a configuration example shown in FIG. 13, the directions of the arrows 61 to 64 are the directions of the forces. The sizes of the arrows 61 to 64, specifically, the thicknesses of the arrows 61 to 64 correspond to the magnitudes of the forces.

By displaying the information concerning the forces as the arrows 61 to 64 in this way, it is possible to easily and quickly grasp the information concerning the forces compared with when the information concerning the forces is displayed as numbers. Note that the predetermined portion of the virtual movable section 30A is not limited to the second point 92 and can be set as appropriate. Examples of the predetermined portion include a point separated a predetermined distance from the second point 92.

### Configuration 5

In the control of the virtual robot 1A by the control section 51, when the virtual robot 1A operates, the control section 51 may further calculate position and posture information of the control point 96 and store the position and posture information of the control point 96 in the storing section 52.

In the configuration 5, the control section 51 is capable of controlling the driving of the virtual robot 1A on the basis of the position and posture information of the control point 96 stored in the storing section 52. Therefore, the control section 51 controls the driving of the virtual robot 1A on the basis of the position and posture information of the control point 96 stored in the storing section 52. Consequently, it is possible to easily and accurately reproduce, in the simulation, the operation performed by the virtual robot 1A.

### Configuration 6

The control section 51 controls the driving of the virtual robot 1A on the basis of the position and posture information of the control point 96 stored in the storing section 52 and information concerning a joint flag of the virtual robot arm 10A. Consequently, it is possible to easily and accurately reproduce, in the simulation, the operation performed by the virtual robot 1A.

Note that the configuration for using the information concerning the joint flag of the virtual robot arm 10A in the control of the driving of the virtual robot 1A can be applied to other configurations.

Other forms are explained.

First, the information stored in the storing section 208 of the robot control device 20 is stored in the storing section 52 of the simulation device 5 and used when necessary in the simulation device 5.

The control section 51 of the simulation device 5 controls the driving of the virtual robot 1A on the basis of predetermined information among the information stored in the storing section 52. The simulation of the simulation device is displayed on the display section 6. Specific configuration examples are explained.

### Configuration 1

The control section 51 causes the display device 6 to display the virtual robot 1A and controls the driving of the virtual robot 1A on the basis of the position and posture information of the control point 96 stored in the storing section 52. Consequently, it is possible to easily and accurately reproduce, in the simulation, the operation performed by the robot 1.

### Configuration 2

The control section 51 causes the display device 6 to display the virtual robot 1A and controls the driving of the virtual robot 1A on the basis of the information concerning the joint angles of the robot arm 10 stored in the storing section 52. Consequently, it is possible to easily and accurately reproduce, in the simulation, the operation performed by the robot 1.

### Configuration 3

The control section 51 causes the display device 6 to display the virtual robot 1A and controls the driving of the virtual robot 1A on the basis of the position and posture information of the control point 96 stored in the storing section 52 and the information concerning the joint flag of the robot arm 10. Consequently, it is possible to easily and accurately reproduce, in the simulation, the operation performed by the robot 1.

Note that the configuration for using the information concerning the joint flag of the robot arm 10 in the control of the driving of the virtual robot 1A can be applied to other configurations.

### Configuration 4

As explained above, when the robot 1 operates, information concerning forces applied to a predetermined portion of the movable section 30, for example, forces applied to the second point 92 is stored in the storing section 208. The information concerning the forces is stored in the storing section 52. In the simulation, the control section 51 causes the display device 6 to display, as the arrows 61, 62, 63, and 64, together with the virtual robot 1A, the information concerning the forces stored in the storing section 52 (see FIGS. 12 and 13). The display as the arrows 61 to 64 is explained above. Therefore, explanation of the display as the arrows 61 to 64 is omitted.

By displaying the information concerning the forces as the arrows 61 to 64, it is possible to easily and quickly grasp the information concerning the forces compared with when the information concerning the forces is displayed as numbers. Note that the predetermined portion of the virtual movable section 30A is not limited to the second point 92 and can be set as appropriate. Examples of the predetermined portion include a point separated a predetermined distance from the second point 92.

As explained above, with the simulation device 5, the information including the position and posture information of the second point 92 is displayed on the display device 6. Consequently, it is possible to easily and quickly grasp the operation performed by the virtual robot 1A. In particular, a person unfamiliar with robotics can easily grasp the position and posture information of the second point 92 compared with the position and posture information of the control point 96. Consequently, it is possible to easily and quickly grasp the operation performed by the virtual robot 1A.

A result of the simulation of the simulation device 5 can be used in control of the robot 1. That is, the robot control device 20 is capable of controlling the robot 1 on the basis of a result of the simulation of the simulation device 5.

As explained above, the simulation device 5 is a device that performs the operation of the virtual robot 1A on the virtual space displayed on the display device 6.

The virtual robot 1A includes the virtual movable section 30A including the virtual robot arm 10A, the virtual end effector 19A detachably attached to the virtual robot arm 10A and configured to hold the virtual object 8A, and the virtual force detecting device 7A.

The simulation device 5 includes the control section 51 that, when the virtual robot 1A (the virtual robot arm 10A) operates, calculates, on the basis of the position and posture information of the first point 91 of the virtual robot arm 10A and the relative position and posture information of the second point 92 of the virtual object 8A with respect to the first point 91, position and posture information of the second point 92 and causes the storing section 52 to store the position and posture information of the second point 92.

With such a simulation device 5, it is possible to easily and quickly grasp, with the position and posture information of the second point 92, the operation performed by the virtual robot 1A.

When the virtual robot 1A operates, the control section 51 causes the storing section 52 to store the information concerning the forces applied to the predetermined portion of the virtual movable section 30A and causes the display device 6 to display, as the arrows 61 to 64, together with the virtual robot 1A, the information concerning the forces stored in the storing section 52.

Consequently, it is possible to easily and quickly grasp, with the display as the arrows 61 to 64, the forces applied to the predetermined portion of the virtual movable section 30A.

### Second Embodiment

A second embodiment is explained below. Differences from the first embodiment are mainly explained. Explanation of similarities is omitted.

In the second embodiment, the robot control device 20 has the function of the simulation device 5. For example, the robot control device 20 can cause the display device 6 to display the virtual robot 1A and the like (see FIG. 11).

In the second embodiment, first, as in the first embodiment explained above, when the robot 1 operates, the control section 207 of the robot control device 20 stores the information concerning the forces applied to the predetermined portion of the movable section 30, for example, the forces applied to the second portion 92 in the storing section 208.

The control section 207 causes the display device 6 to display, as the arrows 61, 62, 63, and 64, together with the virtual robot 1A, the information concerning the forces stored in the storing section 52 (see FIGS. 12 and 13). The display as the arrows 61 to 64 is explained above. Therefore, explanation of the display is omitted.

By displaying the information concerning the forces as the arrows 61 to 64 in this way, it is possible to easily and quickly grasp the information concerning the forces compared with when the information concerning the forces is displayed as numbers. Note that the predetermined portion of the virtual movable section 30A is not limited to the second point 92 and can be set as appropriate. Examples of the predetermined portion include a point a predetermined distance apart from the second point 92.

According to such a second embodiment, the same effects as the effects in the first embodiment explained above can be exhibited.

The robot control device, the robot control method, the robot system, and the simulation device according to the invention are explained above with reference to the embodiments illustrated in the drawings. However, the invention is not limited to the embodiments. The components of the sections can be replaced with any components having the same functions. Any other components and processes may be added.

The invention may be an invention obtained by combining any two or more configurations (characteristics) in the embodiments.

In the embodiments, the storing section is the component of the robot control device. However, in the invention, the storing section may be not the component of the robot control device and may be provided separately from the robot control device.

In the embodiments, the storing section is the component of the simulation device. However, in the invention, the storing section may be not the component of the simulation device and may be provided separately from the simulation device.

In the embodiments, the fixing part of the base of the robot is, for example, the floor in the setting space. However, in the invention, the fixing part is not limited to this. Besides, examples of the fixing part include a ceiling, a wall, a workbench, and a ground. The base itself may be movable.

In the invention, the robot may be set in a cell. In this case, examples of the fixing part of the base of the robot include a floor section, a ceiling section, a wall section, and a workbench in the cell.

In the embodiments, the first surface, which is the plane (the surface) to which the robot (the base) is fixed, is the plane (the surface) parallel to the horizontal plane. However, in the invention, the first surface is not limited to this. For example, the first surface may be a plane (a surface) inclined with respect to the horizontal plane or the vertical plane or may be a plane (a surface) parallel to the vertical plane. That is, the first turning axis may be inclined with respect to the vertical direction or the horizontal direction, may be parallel to the horizontal direction, or may be parallel to the vertical direction.

In the embodiments, the number of turning axes of the robot arm is six. However, in the invention, the number of turning axes of the robot arm is not limited to this. The number of turning axes of the robot arm may be, for example, two, three, four, five, or seven or more. That is, in the embodiments, the number of arms (links) is six. However, in the invention, the number of arms (links) is not limited to this. The number of arms (links) may be, for example, two, three, four, five, or seven or more. In this case, for example, in the robots in the embodiments, by adding an arm between the second arm and the third arm, it is possible to realize a robot including seven arms.

In the embodiments, the number of robot arms is one. However, in the invention, the number of robot arms is not limited to this. The number of robot arms may be, for example, two or more. That is, the robot (a robot body) may be, for example, a plural-arm robot such as a double-arm robot.

In the invention, the robot may be robots of other forms. Specific examples of the robot include a legged walking (running) robot including legs and a horizontal articulated robot such as a SCARA robot.

In the embodiments, the robot control device and the simulation device are the separate devices. However, in the invention, the robot control device and the simulation device are not limited to this. For example, the robot control device may have the function of the simulation device.

The entire disclosure of Japanese Patent Application No. 2017-142450, filed Jul. 24, 2017 is expressly incorporated by reference herein.

What is claimed is:

1. A robot control device comprising:
a processor that is configured to execute computer-executable instructions so as to control a robot including a robot arm, an end effector detachably attached to the robot arm and configured to hold an object, and a force detecting device, wherein
the processor is configured to:
calculate, on the basis of position and posture information of a first point of the robot arm and relative position and posture information of a second point of the object with respect to the first point, position and posture information of the second point when the robot operates; and
cause a memory to store the position and posture information of the second point.

2. The robot control device according to claim 1, wherein the processor is configured to:
calculate, on the basis of force information detected by the force detecting device, a force applied to the second point when the robot operates; and
cause the memory to store information concerning the force applied to the second point.

3. The robot control device according to claim 1, wherein the processor is configured to:
control driving of a display device; and
cause the display device to display, as a list, the position and posture information of the second point stored in the memory and information concerning a force applied to the second point stored in the memory.

4. The robot control device according to claim 1, wherein the second point is set independently from a control point set in the end effector.

5. The robot control device according to claim 1, wherein the position and posture information of the second point is calculated on the basis of a local coordinate system different from a base coordinate system of the robot.

6. The robot control device according to claim 1, wherein the processor is configured to calculate position and posture information of a third point on the basis of the position and posture information of the second point and joint angle information of the robot arm.

7. The robot control device according to claim 1, wherein the processor is configured to:
cause the storing section to store position and posture information of a control point set in the end effector when the robot operates; and
control the robot on the basis of the position and posture information of the control point stored in the memory.

8. The robot control device according to claim 1, wherein, the processor is configured to:
cause the storing section to store joint angle information of the robot arm when the robot operates; and
control the robot on the basis of the joint angle information of the robot arm stored in the storing section.

9. The robot control device according to claim 7, wherein, the processor is configured to:
cause the memory to store information concerning a joint flag when the robot operates; and
control the robot on the basis of the information concerning the joint flag stored in the memory.

10. A robot system comprising:
a robot including a robot arm, an end effector detachably attached to the robot arm and configured to hold an object, and a force detecting device; and
the robot control device including a processor that is configured to execute computer-executable instructions so as to the robot, wherein
the processor is configured to:
calculate, on the basis of position and posture information of a first point of the robot arm and relative position and posture information of a second point of the object with respect to the first point, position and posture information of the second point when the robot operates; and
cause a memory to store the position and posture information of the second point.

11. The robot system according to claim 10, wherein the processor is configured to:
calculate, on the basis of force information detected by the force detecting device, a force applied to the second point when the robot operates; and
cause the memory to store information concerning the force applied to the second point.

12. The robot system according to claim 10, wherein the processor is configured to:
control driving of a display device; and
cause the display device to display, as a list, the position and posture information of the second point stored in the memory and information concerning a force applied to the second point stored in the memory.

13. The robot system according to claim 10, wherein the second point is set independently from a control point set in the end effector.

14. The robot system according to claim 10, wherein the position and posture information of the second point is calculated on the basis of a local coordinate system different from a base coordinate system of the robot.

15. The robot system according to claim 10, wherein the processor is configured to calculate position and posture information of a third point on the basis of the position and posture information of the second point and joint angle information of the robot arm.

16. The robot system according to claim 10, wherein the processor is configured to:
cause the storing section to store position and posture information of a control point set in the end effector when the robot operates; and

17. The robot system according to claim 10, wherein the processor is configured to:
cause the storing section to store joint angle information of the robot arm when the robot operates; and
control the robot on the basis of the joint angle information of the robot arm stored in the storing section.

18. The robot system according to claim 16, wherein, the processor is configured to:
cause the memory to store information concerning a joint flag when the robot operates; and
control the robot on the basis of the information concerning the joint flag stored in the memory.

19. A simulation device that performs operation of a virtual robot on a virtual space displayed on a display device, the virtual robot including a virtual robot arm, a virtual end effector detachably attached to the virtual robot arm and configured to hold a virtual object, and a virtual force detecting device,
the simulation device comprising a processor that is configured to:
calculate, on the basis of position and posture information of a first point of the virtual robot arm and relative position and posture information of a second point of the virtual object with respect to the first point, position and posture information of the second point when the virtual robot operates; and
cause a memory to store the position and posture information of the second point.

20. The simulation device according to claim 19, wherein the processor is configured to:
cause the storing section to store information concerning a force applied to predetermined portion of the virtual robot arm, the virtual end effector or the virtual force detecting device when the virtual robot operates; and
cause the display device to display, together with the virtual robot, as an arrow, the information concerning the force stored in the memory.
